(19) United States
(12) Patent Application Publication
(10) Pub. No.: US 2015/0277949 A1
(43) Pub. Date: Oct. 1, 2015

(54) SECURING SHARED INTERCONNECT FOR VIRTUAL MACHINE

(71) Applicants: THIAM WAH LOH, Singapore (SG); GAUTHAM N. CHINYA, Hillsboro, OR (US); STEPHEN J. ROBINSON, Austin, TX (US); REZA FORTAS, Villeneuve Loubet (FR); HONG WANG, Santa Clara, CA (US); HELMUT REINIG, Isen (DE); PER HAMMARLUND, Hillsboro, OR (US); DEEPAK A. MATHAIKUTTY, Santa Clara, CA (US); CHRISTIAN ERBEN, Munich (DE)

(72) Inventors: THIAM WAH LOH, Singapore (SG); GAUTHAM N. CHINYA, Hillsboro, OR (US); STEPHEN J. ROBINSON, Austin, TX (US); REZA FORTAS, Villeneuve Loubet (FR); HONG WANG, Santa Clara, CA (US); HELMUT REINIG, Isen (DE); PER HAMMARLUND, Hillsboro, OR (US); DEEPAK A. MATHAIKUTTY, Santa Clara, CA (US); CHRISTIAN ERBEN, Munich (DE)

(21) Appl. No.: 14/227,166

(22) Filed: Mar. 27, 2014

(51) Int. Cl. G06F 9/455; G06F 13/16; G06F 13/364; G06F 12/14

(52) U.S. Cl. CPC G06F 9/45558; G06F 12/145; G06F 13/1684; G06F 13/364; G06F 2009/45587; G06F 2212/1052

(57) ABSTRACT

A processing system includes an interconnect and a processing core, coupled to the interconnect, to execute a plurality of virtual machines each being identified by a respective identifier, and tag, by an identifier of the first virtual machine, a first transaction initiated by a first virtual machine to access the interconnect.

### TECHNICAL FIELD

The embodiments of the disclosure relate generally to a processing system, and, more specifically, relate to securing the shared interconnect of a processing system that executes virtual machines.

### BACKGROUND

A processing system may include a shared interconnect through which processing units (such as central processing units (CPUs) and graphic processing units (GPUs)), master devices (referred to as bus maters hereinafter), and slave devices (referred to as bus slaves hereinafter) may communicate with each other. The bus slaves may include peripheral devices and a memory. The peripheral devices and memory may communicate with the processing system and bus masters through the interconnect. The processing units may execute a virtualization system which may include one or more virtual machines to provide further resource sharing. However, the shared interconnect may expose bus slaves to malicious attacks from a surreptitious bus master. Further, the virtualization system subjects bus slaves to malicious attacks from a surreptitious virtual machine.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a processing system according to an embodiment of the present disclosure.

FIG. 2A illustrates firewall rules to protect memory according to an embodiment of the disclosure.

FIG. 2B illustrates firewall rules to protect peripheral devices according to an embodiment of the disclosure.

FIG. 3A illustrates operations to set up the processing system according to an embodiment of the disclosure.

FIG. 3B illustrates access control of CPU transactions and bus master transactions according to an embodiment of the disclosure.

FIG. 4 is a flow diagram of a method for the processing system as shown in FIG. 1 according to an embodiment of the disclosure.

FIG. 5A is a block diagram illustrating a micro-architecture for a processor in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure

FIG. 11 is a block diagram of an embodiment of an SoC design in accordance with the present disclosure.

FIG. 12 illustrates a block diagram of one embodiment of a computer system.

### DETAILED DESCRIPTION

To protect bus slaves from malicious attack through a shared interconnect, embodiments of the present disclosure include a processing system that associates each transaction to access the bus slaves with an identifier that identifies the virtual machine for which the transaction is executed for. Further, embodiments may provide one or more firewalls to the interconnect to validate the transaction that intends to access the bus slaves using the identifier of the virtual machine.

Although the following embodiments may be described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Although the following embodiments are described with reference to a processor, other embodiments are applicable to other types of integrated circuits and logic devices. Similar techniques and teachings of embodiments of the disclosure can be applied to other types of circuits or semiconductor devices that can benefit from higher pipeline throughput and improved performance. The teachings of embodiments of the disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

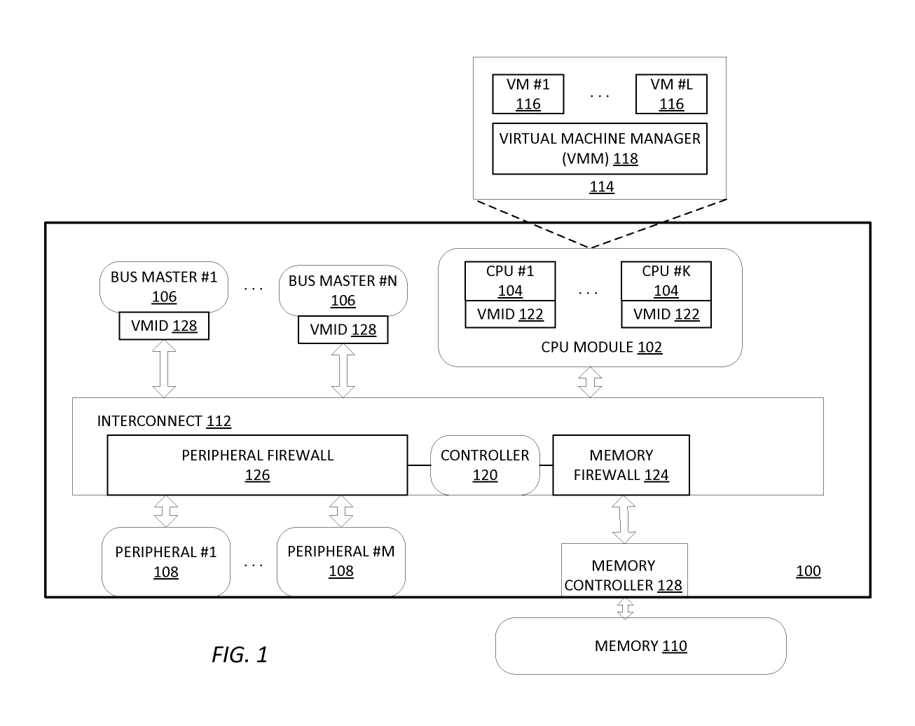

FIG. 1 illustrates a processing system 100 according to an embodiment of the present disclosure. In one embodiment, the processing device 100 may be a system-on-a-chip hardware circuit that may be implemented on a single die (a same substrate) within a single semiconductor package. The processing system may include a central processing unit (CPU) module 102, bus masters (#1 through #N)) 106, bus slaves (#1 through #M) 108, a memory device 110, and an interconnect 112.

The CPU module 102 may further include central processing units (CPUs) (#1 through #K) 104, and each CPU may include one or more processing cores (not shown). CPUs 104 and/or processing cores may execute a virtualization system 114 to allow multiple instances of one or more operating systems to run on processing system 100 referred to as the hosting processing device (“host”). Thus, processing system 100 may be the host that hosts virtualization system 114. Virtualization system 114 may be implemented in hardware (also known as hardware-assisted virtualization). Instruction sets of CPUs 104 may be extended to include instructions to launch and exit virtual machines so that virtualization system 114 may be implemented in a hardware-assisted fashion. In hardware-assisted virtualization, a software module known as virtual machine manager (“VMM,” also referred to as a hypervisor) 118 may be used to create and manage one or virtual machines 116 (also referred to as guest machines). VMM 118 may present each virtual machine with a guest operating system and manage the execution of the guest operating systems. Application software (also referred to as guest software) may be executed on virtual machines 116. Thus, multiple instances of application software may be executed on virtual machines 116 by sharing the hardware resources of the processing system 100 through the virtualization system 114.

VMM 118 may run directly on the host's hardware by controlling hardware components of processing system 100 and manage guest operating systems of virtual machines 116. This is commonly referred to as a type-I VMM. Alternatively, VMM 118 may run within the operating system (also referred to as host operating system) of processing system 100. This is commonly referred to as a type-II VMM. Under either type of VMM, instructions of guest operating system and guest application software executed on virtual machines may be translated into instructions to CPUs 104 and executed by these CPUs.

Each of CPUs 104 may include processing cores (not shown) to execute instructions and cache memory (“cache”) to store instructions and data associated with the instructions locally for fast storage and retrieval. Commonly, each CPU may have different levels of cache. Typically, each processing core may have its own L1 and L2 cache although L1 cache is smaller and faster than L2 cache, and multiple cores may share L3 cache which is larger and slower than the L1 or L2 cache. CPUs 104 may execute operations under the control of VMM or host operating system on behalf of virtual machines. Operations performed by CPUs 104 to move data and instructions in and out of the CPU module 102 to interconnect 112, and then to peripheral devices 108 or to memory 110, are referred to as CPU transactions. CPU transactions that are cached by L1/L2 cache are referred to as cached transactions. For example, if the cached transactions are to access peripheral devices 108 and/or memory 110, they may also be referred to as cached CPU access. In contrast, CPU transactions that are not cached by L1/L2 cache are referred to as un-cached transactions.

Interconnect 112 may be a bus system through which different hardware components (such as processing units 104, bus masters 106, peripheral devices 108, memory 110) communicate with each other. The content of the communication may include CPU transactions directed to the memory 110 and peripheral devices 108. The CPU transactions may include instructions and data associated with the instructions to be carried out for virtual machines. In addition to providing a shared communication fabric linking these hardware components, interconnect 112 may also include a controller 120 to control the traffic on the shared communication link. For example, in response to receiving a CPU transaction directed to access memory 110, controller 120 may parse the CPU transaction to identify an address range of the memory, and write or read the content at the address range through memory controller 128. Further, CPUs may also transmit transactions to peripheral devices 108 through peripheral controllers (not shown). In one embodiment, each peripheral device may include a controller, and in another embodiment, multiple peripheral devices may share a controller.

Bus masters 106 may include controllers and microprocessors that are programmed with executable codes to direct traffic to the interconnect 112 and then to peripheral devices 108 memory 110. In one implementation, a bus master may be a direct memory access (DMA) controller that access memory on behalf of CPUs. Thus, bus masters 106 may, at the direction of a CPU, gain access to the interconnect 112, and also generate bus master transactions, i.e., those operations that move instructions and data in and out of bus masters (referred to as BM transactions hereinafter). BM transactions may be executed by bypassing CPUs. In the scenario of virtualization system, a CPU (or processing core) may offload certain CPU transactions of a virtual machine to a bus master so that the bus master may direct BM transactions designated to the virtual machine to peripheral devices 108 and/or memory 110 through interconnect 112. Further, controller 120 of interconnect 112 may parse the BM transactions to access (write or read) contents at the appropriate peripheral devices 108 and/or memory ranges of memory 110.

Interconnect 112 may receive CPU transactions and BM transactions without knowing which virtual machine originated a particular transaction. Because there is no context awareness of the owner of these transactions, any virtual machines running on CPUs 104 may access any portion of memory 110 and any peripheral devices 108. Further, any bus masters 106 may access any portion of memory 110 and any peripheral devices 108. Thus, the shared interconnect 112 and virtualization system 114 that transmit transactions without identifying the ownership of these transactions make memory 110 and peripheral devices 108 vulnerable to malicious attacks.

Embodiments of the disclosure may include a processing system that include processing logics to associate a transaction (either a CPU or a BM transaction) with an identifier of the virtual machine for which the transaction is executed. In one embodiment, the identifier is the virtual machine identification (VMID) that is automatically generated prior to the creation of the virtual machine and stored in an internal register of the CPU. Each VMID uniquely identifies a virtual machine. Alternatively, the identifier can be any alpha-numerical string that may be assigned to a virtual machine to identify the virtual machine. Thus, a transaction associated with the identifier of the virtual machine may be traced to the virtual machine. For simplification and brevity, the identifier of the virtual machine and VMID are used interchangeably without limiting the identifier of a virtual machine to a particular type of identifier except for that the identifier uniquely identifies a virtual machine. Further, embodiments may provide for processing logics in interconnect 112 to validate the received transaction using the identifier of the virtual machine and/or a memory range allocated to the virtual machine. In this way, peripheral devices 108 and memory 110 may be protected from unwanted accesses or malicious attacks even though transactions are still transmitted through the shared interconnect 112 and from virtualization system 114.

FIG. 1 illustrates the processing system 100 with further details according to embodiments of the disclosure. Referring to FIG. 1, each of virtual machines 116 may be identified with an identifier (e.g., a VMID). The identifier may be a bit sequence that is capable of uniquely identify a virtual machine. In one embodiment, the identifier may be a universal unique identifier (UUID) assigned to the virtual machine when the virtual machine is powered on or reset. In one embodiment, the identifier may be an N-bit integer (where N may be any length) and may be stored in an internal register of the CPU executing the virtual machine. The identifier may be accessed through a system utility of VMM 118.

In one embodiment, each of CPUs 104 may include a processing logic 122 to determine the identifier of the virtual machine from which an operation is originated. The identifier may be provided by VMM 118 when it transmits operation from the virtual machine to CPU module 102. In one embodiment, the virtualization may be achieved in hardware-assisted fashion using virtualization technology which may has an extra instruction set (e.g., Virtual Machine Extensions or VMX of x86 processors) to create VMM and virtual machines). For example, using VMX as an example, a CPU may enter into virtual mode by executing a VMM start command (e.g., VMXON) to start a VMM 118 in root operation. Under root operation, VMM 118 may be associated with an identifier reserved for the root operation, e.g., VMID=0. Under the root operation, VMM 118 may use the root identifier to set up hardware components as described in the following sections. Subsequently, under the virtual mode, VMM 118 may create a virtual machine using virtual machine entry command (e.g., VM_ENTRY). At the creation of the virtual machine, virtual machine context switching behaviors may follow. For example, the VMID identifying the virtual machine may be created and stored in an internal register of the CPU. The virtual machine operates in a non-root operation. Each subsequent transaction originated by the virtual machines may be tagged with the VMID by processing logic 122. However, when the virtual machine exits (e.g., using VM_EXIT command), the identifier stored in the internal register and the VM context may be removed, and the root operation mode of VMM may return upon the exit of the virtual machine.

The operations requested by the virtual machine may include CPU transactions accessing memory 110 or peripheral devices 108 through interconnect 112. Thus, for each of transactions to the shared interconnect 112 by the entered virtual machine, processing logic 122 may read the internal register that stores the VMID and tag the transaction with the identifier. In this way, CPU transactions are associated with the virtual machine from which the CPU transactions are generated.

In one embodiment, the CPU may associate each bus master 106 with one virtual machine at a given time. The CPU may cause to store the VMID of the associated virtual machine in a register 128 of the bus master 106. The CPU may execute the VMM 118 to assign the VMID to the bus master at the initiation of the virtual machine. In one embodiment, the virtual machine associated with the bus master may be changed during the runtime of the virtual machine system 114. Corresponding to the change of the associated virtual machine, the CPU may correspondingly update the identifier stored in the register 128 to include the VMID of the currently associated virtual machine. Thus, when the bus master issues a BM transaction to a bus slave (a peripheral device or the memory), a controller of the bus master may first tag the transaction with the VMID stored in the register 128. In this way, BM transactions are associated with VMIDs of virtual machines for which the BM transactions are performed.

In one embodiment, each virtual machine at creation may be assigned by VMM 118 to use a specific portion of the memory. For example, VMM 118 may designate a virtual machine to access an address range of the memory so that different virtual machines may access different address ranges of the memory. In one embodiment, the processing logic 122 of a CPU 104 may also tag the memory address range of the virtual machine (in addition to the VMID of the virtual machine) with each CPU transaction directed to the shared interconnect 112 for accessing memory 110. Similarly, a bus master may also tag the memory address range of the virtual machine (in addition to the identifier of the virtual machine) with each BM transaction directed to the shared interconnect 112 for accessing memory 110. In this way, transactions to access memory 110 may be further identified with memory address ranges.

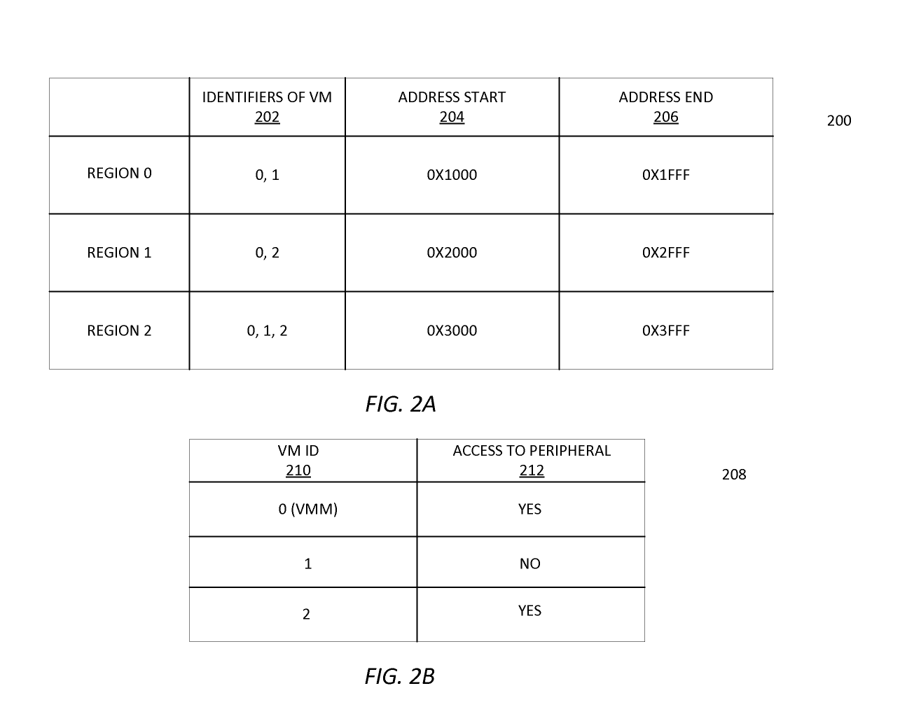

In one embodiment, interconnect 112 may include one or more firewalls to check transactions passing through. In one embodiment, interconnected may include a memory firewall 124 to control those transactions directed to interconnect 112 and subsequently to memory 110 (memory may be RAM or block storage such as embedded multimedia controller (eMMC)). Memory firewall 124 may include controller 120 of interconnect 112 and rule-based policies to control the access to the memory 110. Controller 120 may implement one or more rules to determine if the received transaction (PU transaction or BM transaction) may be executed according to the one or more rules of memory firewall 124. In one embodiment, the one or more rules may include the allowable one or more identifiers and their corresponding memory address ranges. FIG. 2A illustrates a table 200 of example rules to protect interconnect 112 according to an embodiment of the disclosure. Table 200 may be stored in a register accessible by controller 120. Referring to FIG. 2A, each row of table 200 may represent one rule that may allow a transaction to access a portion of memory 110. As shown in FIG. 2A, each row may include a first section (VMID) 202 to indicate identifiers of allowable virtual machines, and second 204 and third 206 sections to indicate start and end address of an address range. In response to receiving a transaction (from CPUs 104 or from bus masters 106), controller 120 may receive the identifier and address range of the associated virtual machine from the transaction. Subsequently, controller 120 may compare the received identifier and address range with allowable virtual machines and corresponding address ranges. If they satisfy one of the rules (such as Regions 0-2), memory firewall 124 may allow the execution of the transaction to access the memory address range by the virtual machine identified by the VMID. However, if a transaction that is directed at interconnect 112 does not satisfy any of the rules in table 200, the transaction to access memory 110 may be denied by memory firewall 124. For example, firewall 124 may allow the execution of the transaction including an identifier of virtual machine #1 and corresponding memory address range within 0x1000-0x1FFF. However, a transaction for virtual machine #3 may be denied because the transaction does not satisfy any rule. In this way, unauthorized accesses (or malicious attacks) may be prevented by firewall 124 based on the contextual content in transactions.

In one embodiment, interconnect may also include a peripheral firewall 126 to control those transaction accesses directed to these peripheral devices 108. Peripheral firewall 126 may include controller 126 and rule-based policies to control the access to the peripheral device. Controller 120 may implement the access policies as one or more rules to determine if a received transaction (PU transaction or BM transaction) may be executed according to the one or more rules of peripheral firewall 126. In one embodiment, one or more rules of peripheral firewall 126 may include one or more VMIDs of virtual machines. In one embodiment, peripheral firewall 126 may be an address decoding circuit logic that may detect identifiers of allowable virtual machines.

FIG. 2B illustrates a table 208 of firewall rules to protect a peripheral device according to an embodiment of the disclosure. Table 208 may be stored in a register that is accessible by controller 120. As shown in FIG. 2B, table 202 may include a list of identifiers of virtual machines 210 and their corresponding access permissions 212 to the peripheral machine. Thus, the controller 120 may receive and compare the VMID of virtual machine from a received transaction with the access permission stored in table 208. If the identified virtual machine has the access permission, peripheral firewall 126 may allow the execution of the transaction on the peripheral device. However, if peripheral firewall 126 determines that the controller does not have access permission, peripheral firewall 126 may deny the transaction from accessing the bus slave. For example, transactions from virtual machine #1 would be denied, while transactions from virtual machine #2 would be allowed to access the peripheral device. In this way, peripheral devices may also be protected from malicious attacks from unauthorized virtual machines or bus masters. In one embodiment, memory firewall 124 and peripheral firewall 126 are two separate firewalls. In another embodiment, memory firewall 124 and peripheral firewall 126 may be implemented as one firewall that controls accesses to memory 110 and peripheral devices 108.

In one embodiment, firewalls 124, 126 may include a root (super user) access identifier that allows transactions with the root access identifier to configure memory firewall 124 and peripheral firewall 126. The root access may be useful to set up the register 128 in a bus master which stores the VMID of the virtual machine associated with the bus master, and to set up memory firewall 124 and peripheral firewall 126 at start of the processing system 100 or at entry of a virtual machine during run time. The root access may also be useful for debugging hardware. In one embodiment, the root access may be identified with an identifier of “0.” In one embodiment, VMM 118 may be assigned with the root access identifier so that VMM may, at the creation of a virtual machine or at exit of a virtual machine, set up the identifiers of virtual machines at bus masters 106, and access policies at firewalls 124, 126. For example, VMM 118 may use the root access to write the register 128 of a bus mater that is assigned to the virtual machine with the VMID of the virtual machine. VMM 118 may also use the root access to update rules of firewalls 124, 126 to include the VMID of the virtual machine and, for memory firewall 124, memory address ranges. Thus, rules of firewalls 124, 126 as shown in FIGS. 2A-2B include root access permission for VMM 118. Further, root access may also be given to debug tools so that it may debug hardware errors.

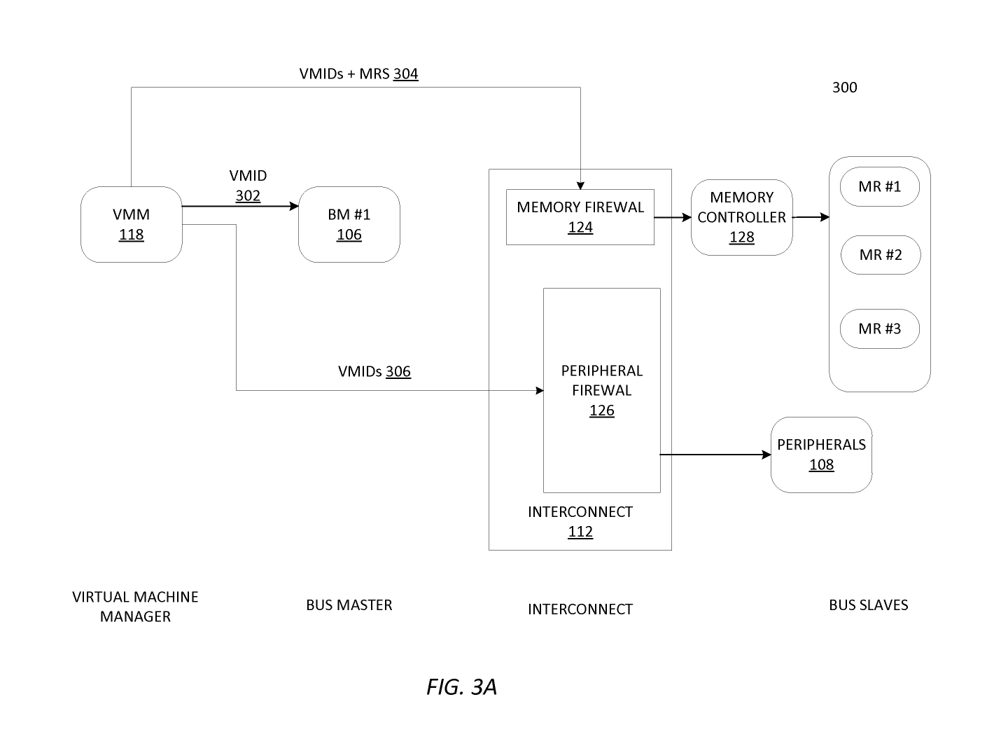

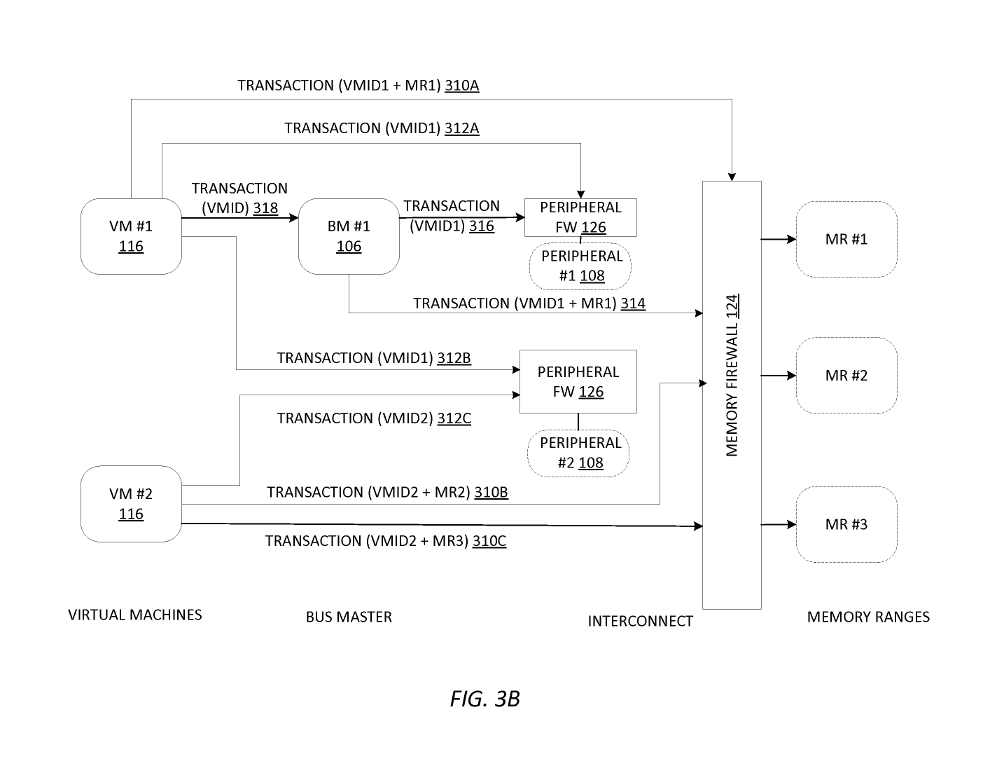

VMM 118 with root access to bus masters 106, and firewalls 124, 126 may configure registers 128 of bus masters, and rule-based policies of firewall 124, 126 at the reset of processing system 100. FIG. 3A illustrates operations that VMM 118 may perform at a reset of processing system 100 to secure shared interconnect 112 and bus slaves against unauthorized accesses according to an embodiment of the disclosure. Referring to FIG. 3A, when processing system 100 is reset (e.g., at the power-up), CPUs 104 of processing system 100 may start VMM 118 first. At onset, VMM 118 may execute a start code which may include instructions (such as a VMXON instruction) to enable Virtual Machine eXtensions (VMX) operations. The start code (such as VMXON instruction) may place one or more CPUs 104 in the mode of root access (e.g., VMX_ROOT).

With root access, VMM 118 may have full access to interconnect 112, bus masters 106 to set up each bus master 106 to be associated with one virtual machine, and memory firewall 124 and peripheral firewalls 126. For example, as shown in FIG. 3A, VMM 118 may execute virtual machine launch command to create one or more virtual machines each being associated with a respective VMID. Subsequently, at 302, VMM 118 may set up bus masters 106. For example, VMM 118 may write the VMID of one virtual machine to an internal register of a bus master (e.g., bus master #1) to associate the bus master (BM #1) with the virtual machine.

At 304, VMM 118 may set up (and update) rule-based policy for memory firewall 124 in interconnect 112 to control the access to memory 110. For example, memory 110 may be partition into different ranges (e.g., MR #1-#3) that may be access by virtual machines. VMM 118 may transmit and enter one or more rules into a rule table (such as rule table 200) of memory firewall 124. Each rule may include VMIDs of virtual machines that have a permission to access memory 110 and corresponding address ranges of these virtual machines. Memory firewall 124 may be used to control access by transactions (PU transactions or BM transactions) to regions of memory 110. For example, transactions including allowable identifiers of virtual machines and within corresponding address ranges of memory 110 may be executed to access to the memory address ranges. However, transactions that do not include allowable identifiers or are not within corresponding memory address ranges may be denied.

At 306, VMM 118 may also set up (and update) rule-based policy of peripheral firewalls 126 for peripheral devices 108 to control access to peripheral devices 108. For example, VMM 118 may transmit and enter one or more rules into a rule table (such as rule table 208) of peripheral firewalls 126. Each peripheral device may have a respective rule table, and each rule may include VMIDs of virtual machines that have permission to access the peripheral device. Peripheral firewall 126 may then be used to control access by transactions (PU transactions or BM transactions) to the peripheral device. For example, transactions including allowable identifiers of virtual machines may be executed to access to the peripheral device. However, transactions that do not include allowable identifiers may be denied.

Once VMM 118 sets up memory firewall 124, peripheral firewall 126, and registers 128 of bus masters 106, CPU transactions and BM transactions to memory 110 and peripheral devices 108 may be examined and controlled according to VMIDs associated with CPU/BM transactions at firewalls 124, 126. CPU/BM transactions to memory 110 through interconnect 112 may further be examined and controlled according to memory address ranges associated with identifiers of virtual machines of CPU/BM transactions.

FIG. 3B illustrates access control of CPU/BM transactions according to an embodiment of the disclosure. Virtual machines 116 may execute CPU transactions that may attempt to access memory 110 and/or access peripheral devices 108. Further, bus masters (such as bus master 106 associated with virtual machine #1) may also execute BM transactions that may attempt to access memory 110 and/or access peripheral devices 108. Referring to FIG. 3B, for example, virtual machine #1 may execute CPU transactions 310A-310C that attempt to access to interconnect 112 in order to access address ranges of memory 110. Transaction 310A may include the identifier of virtual machine #1 (VMID1) and a memory address range (MR1) associated with the identifier (VMID1). In response to receiving the request of transaction 310A, memory firewall 124 in interconnect may compare identifier (VMID1) and memory address range (MR1) against rules of memory firewall 124 to determine if transaction 310A may be executed to access the address range of memory 110. If it can, memory firewall 124 may allow transaction 310A to access the memory address range (MR1). If it cannot, firewall 124 may deny transaction 310A of the access to memory 110. Similarly, transactions 310B-310C may be tagged with virtual machine #2 (VMID2) and memory address ranges (MR2, MR3) respectively. Similarly, in response to receiving requests of transactions 310B, 310C, memory firewall 124 in interconnect may compare identifier (VMD2) and memory address ranges (MR2, MR3) against rules of firewall 124 to determine if transactions 310B, 310C may be executed to access memory address ranges (MR2, MR3).

Virtual machine #1 may also issue a request of transaction 312A including identifier (VMID1) in an attempt to access peripheral device #1 and transaction 312B including identifier (VMID1) to peripheral device #2. Peripheral firewall 126 may compare VMID of virtual machine #1 against rules for peripheral device #1 in peripheral firewall 126 to determine if virtual machine #1 may access peripheral device #1. If transaction 312A can, peripheral firewall 126 may allow transaction 312A to access peripheral device #1. However, if transaction 312A cannot, peripheral firewall 126 may deny transaction 312A from accessing peripheral device #1. Similarly, peripheral firewall 126 may control access from virtual machine #1 to peripheral #1. Similarly, virtual machine #2 may issue a transaction 312C including identifier (VMID2) to attempt to access peripheral device #2. Firewall 126 of peripheral device #2 may compare the identifier (VMID2) against rules of firewall 126 to determine if transaction 312C has the permission to access peripheral device #2. If it can, transaction 312C may be allowed to access peripheral device #2. However, it cannot, the access request by transaction 312C may be denied.

Bus master 106 may issue transaction attempting to access memory 110 and/or peripheral devices 108. Each bus master is associated with one virtual machine. For example, bus master #1 may have been associated with virtual machine #1 by the VMM (318) and include an internal register having stored thereon the VMID of virtual machine #1 (VMID1). Bus master #1 may issue a request to execute transaction 314 including the identifier (VMID1) and the memory address range (MR1) associated with the identifier to interconnect 112. In response to receiving the request of transaction 314, memory firewall 124 may compare the identifier and associated memory address range against rules of memory firewall 124 to determine if transaction 314 may be executed to access memory 110. If it can, memory firewall 124 may allow transaction 314 to access memory address range (MR1). However, if it cannot, the request by transaction 314 to access memory 110 may be denied. Similarly, bus master 106 may issue transaction 316 including the identifier (VMID1) attempting to access peripheral device #1. In response to receiving the request of transaction 316, peripheral firewall 126 in interconnect 112 may compare the identifier against rules of firewall 216 to determine if transaction 316 has the permission to access peripheral device #1. If it can, peripheral firewall 126 may allow transaction 316 to access peripheral device #1. However, if it cannot, peripheral firewall 126 may deny transaction 316 from accessing peripheral device #1.

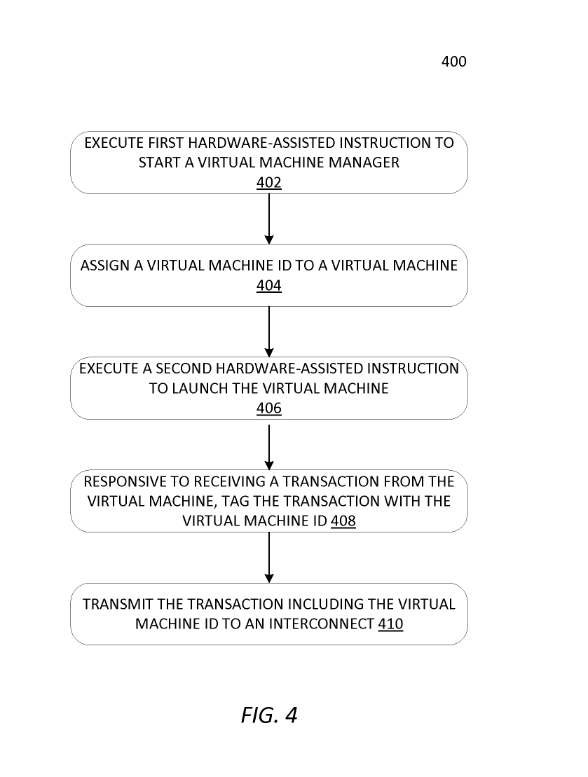

FIG. 4 is a flow diagram of a method to operate a processing system according to an embodiment of the disclosure. Method 400 may be performed by processing logic that may include hardware (e.g., circuitry, dedicated logic, programmable logic, microcode, etc.), software (such as instructions run on a processing system, a general purpose computer system, or a dedicated machine), firmware, or a combination thereof. In one embodiment, method 400 may be performed, in part, by processing logics of any one of the CPUs 104 and controller 120 executing firewalls 124, 126 described with respect to FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4, at 402, a CPU that supports an instruction set including hardware-assisted virtual machine instruction may execute a virtual machine manager start instruction (such as VMXON) to start a virtual machine manager. The CPU may assign virtual machine manager with root access to hardware components to set up a processing system. The processing system may include the CPU, an interconnect, a memory, and peripheral devices, where the CPU, memory, and peripheral devices communicate with each other through the interconnect.

At 404, the CPU may execute the VMM to assign each virtual machine a virtual machine identifier (VMID). The VMID may be automatically generated at the creation of the VMM. The VMM may use its root access to set up rules of a firewall in the interconnect. For example, the VMM may specify in the rules according to which the transactions tagged with specified VMIDs may access the memory and/or a peripheral device. The VMID may have been stored in an internal register of the CPU.

At 406, the CPU may execute another hardware-assisted virtual machine instruction (VM_ENTER) to launch a virtual machine. The virtual machine may run a guest operating system and applications which may generate transactions accessing the memory and/or peripheral devices through the interconnect.

At 408, in response to receiving a transaction from the virtual machine, the CPU may tag the transaction with the VMID so that the transaction is associated with the virtual machine identified by the VMID. The VMID may be stored in an addressable field of the transaction. At 410, the CPU may transmit the transaction including the VMID to a firewall of the interconnect. The firewall may then determine whether the transaction may access the memory and/or peripheral devices by comparing the rules associated with the firewall with the VMID.

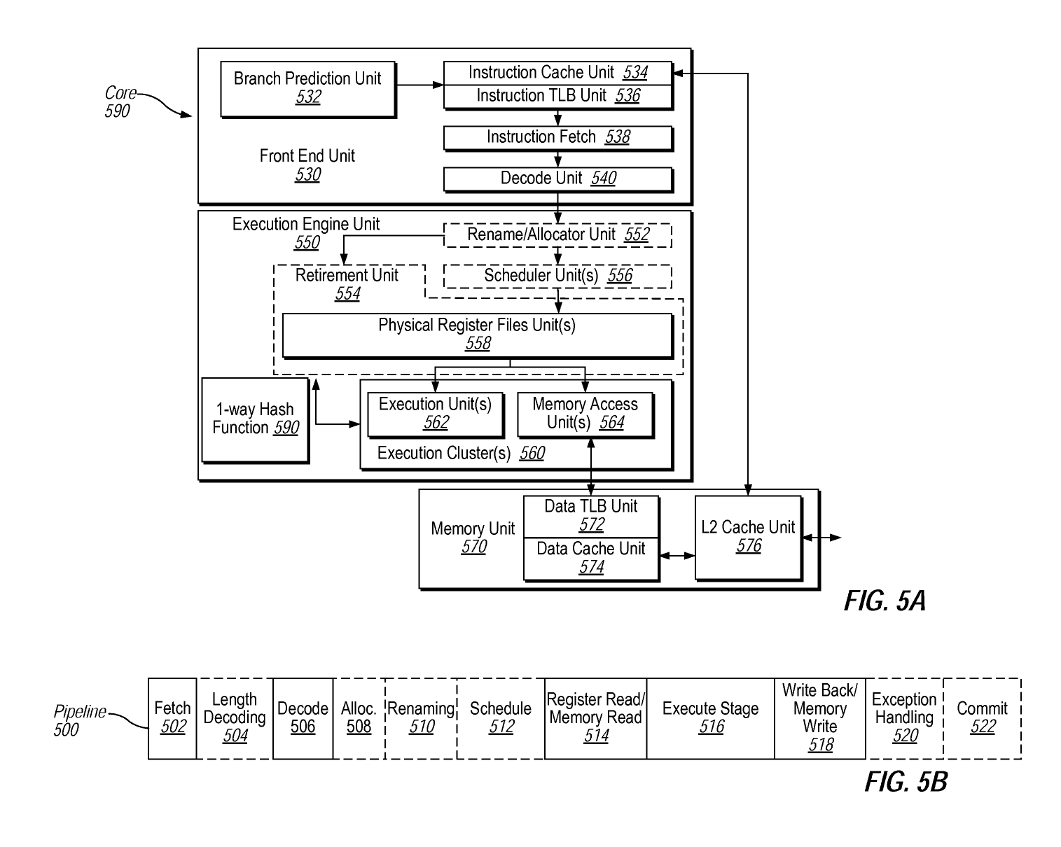

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processing device 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

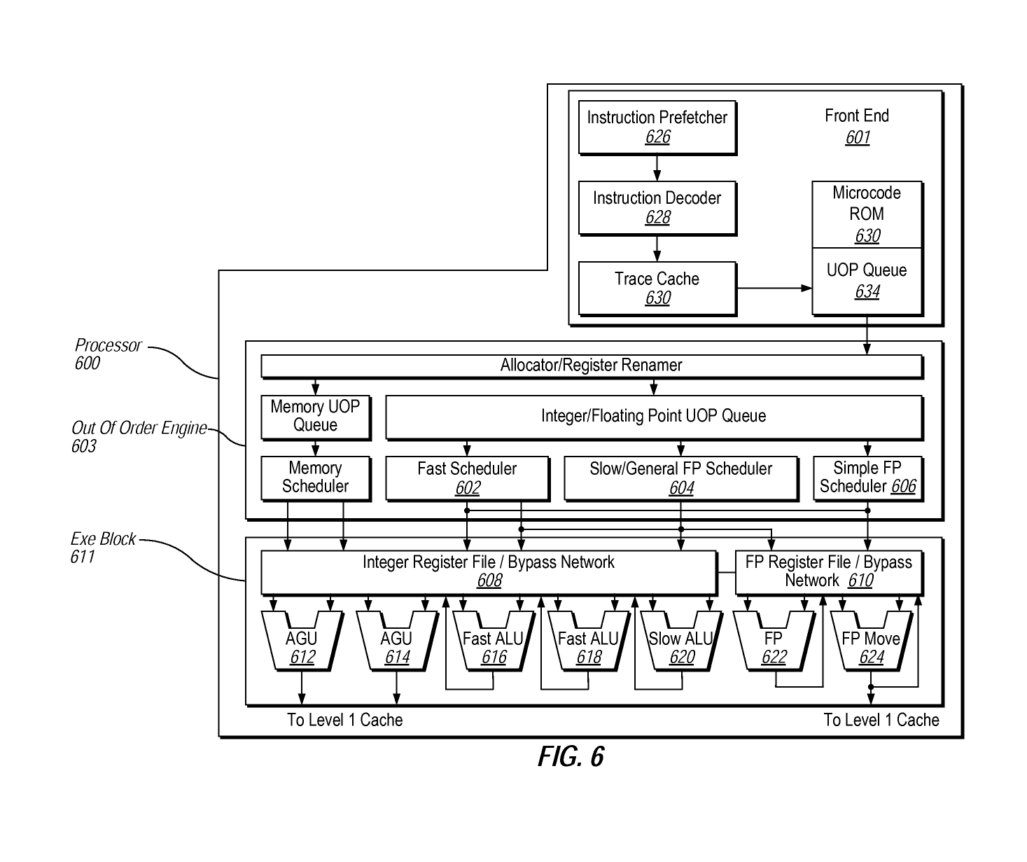

FIG. 6 illustrates a block diagram of the micro-architecture for a processor 600 in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

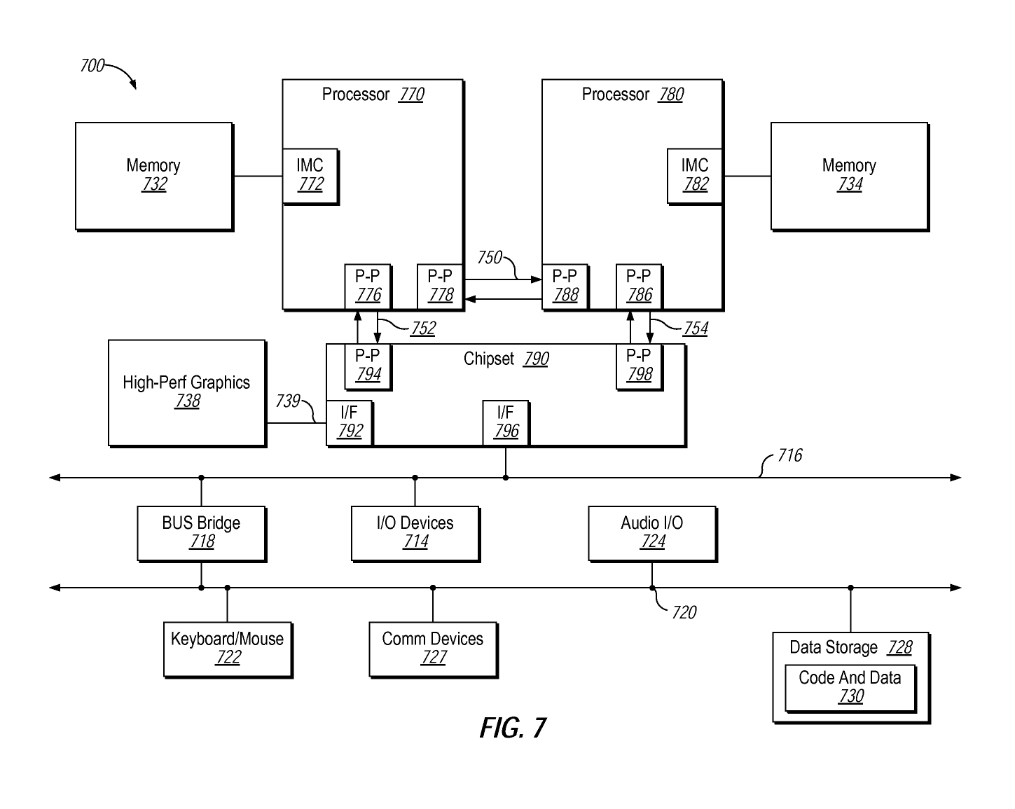

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that embodiments of the disclosure are not so limited. In other embodiments, one or more additional processors may be present in a given processor.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

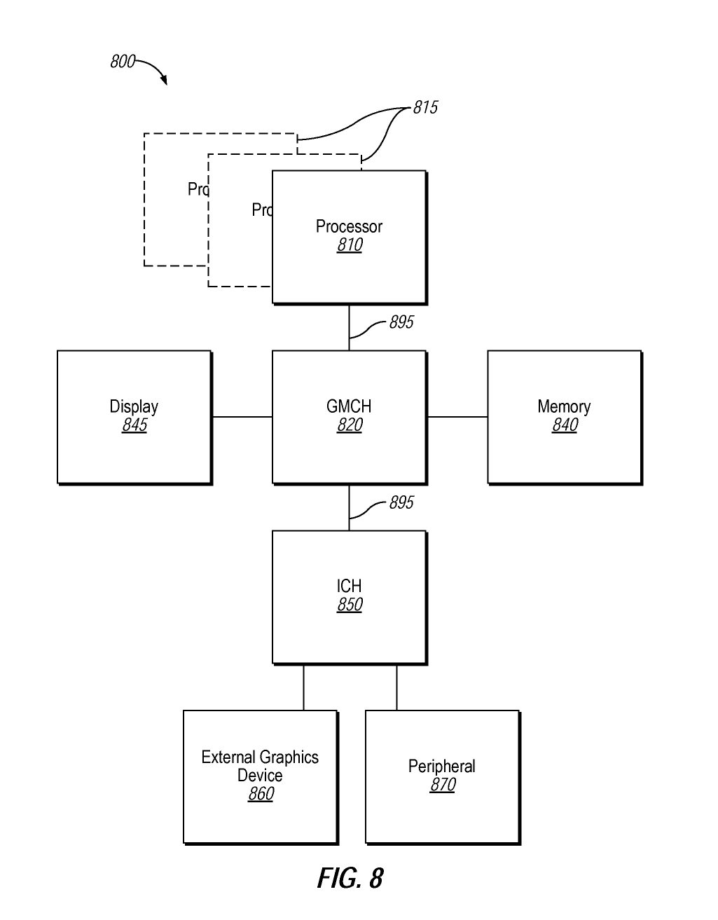

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

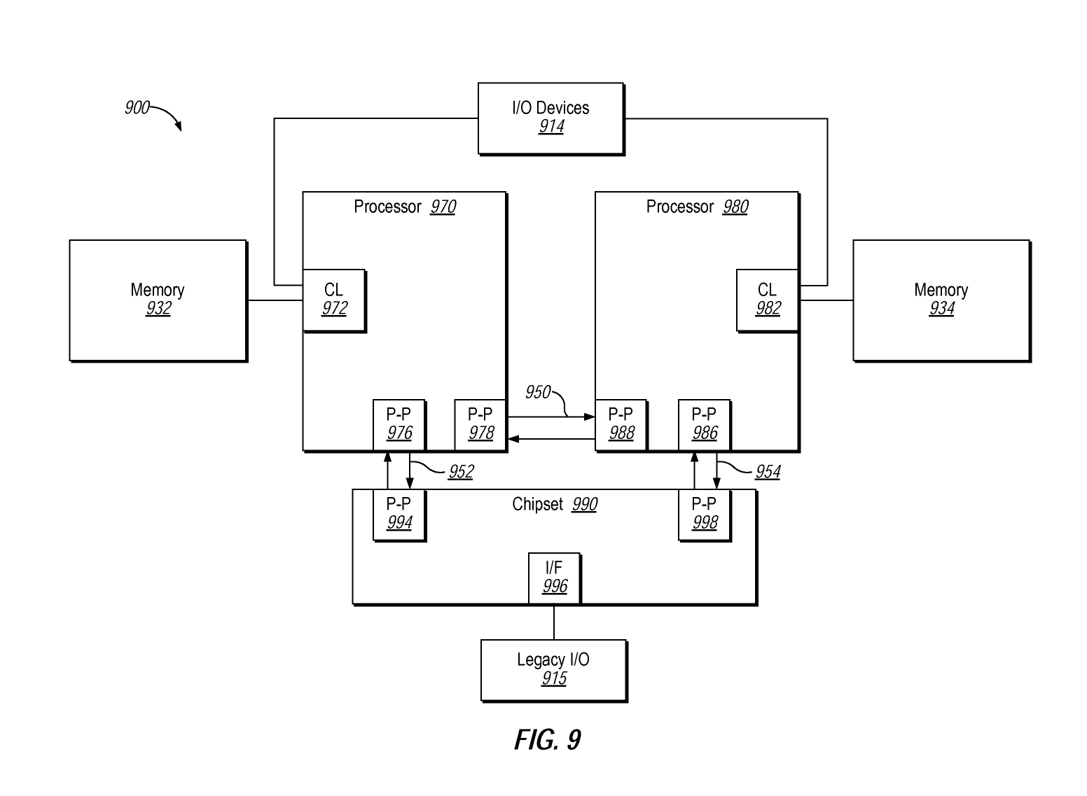

Referring now to FIG. 9, shown is a block diagram of a system 900 in which an embodiment of the disclosure may operate. FIG. 9 illustrates processors 970, 980. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

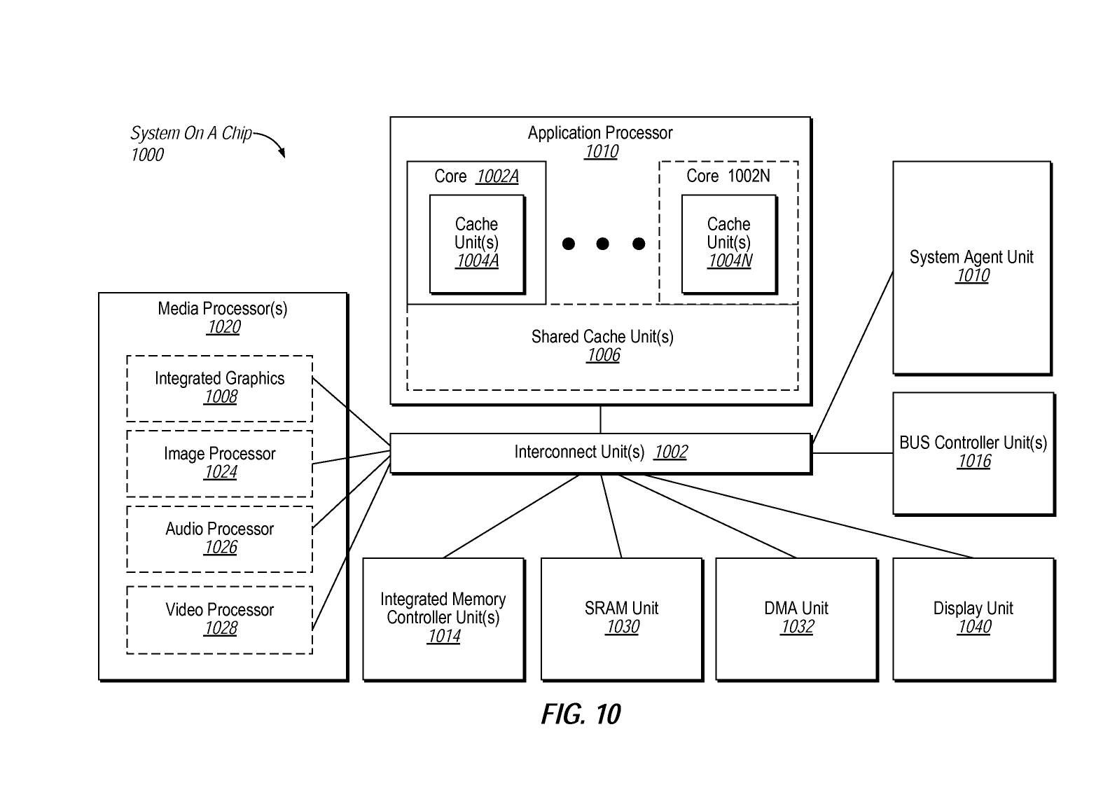

Embodiments may be implemented in many different system types. FIG. 10 is a block diagram of a SoC 1000 in accordance with an embodiment of the present disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

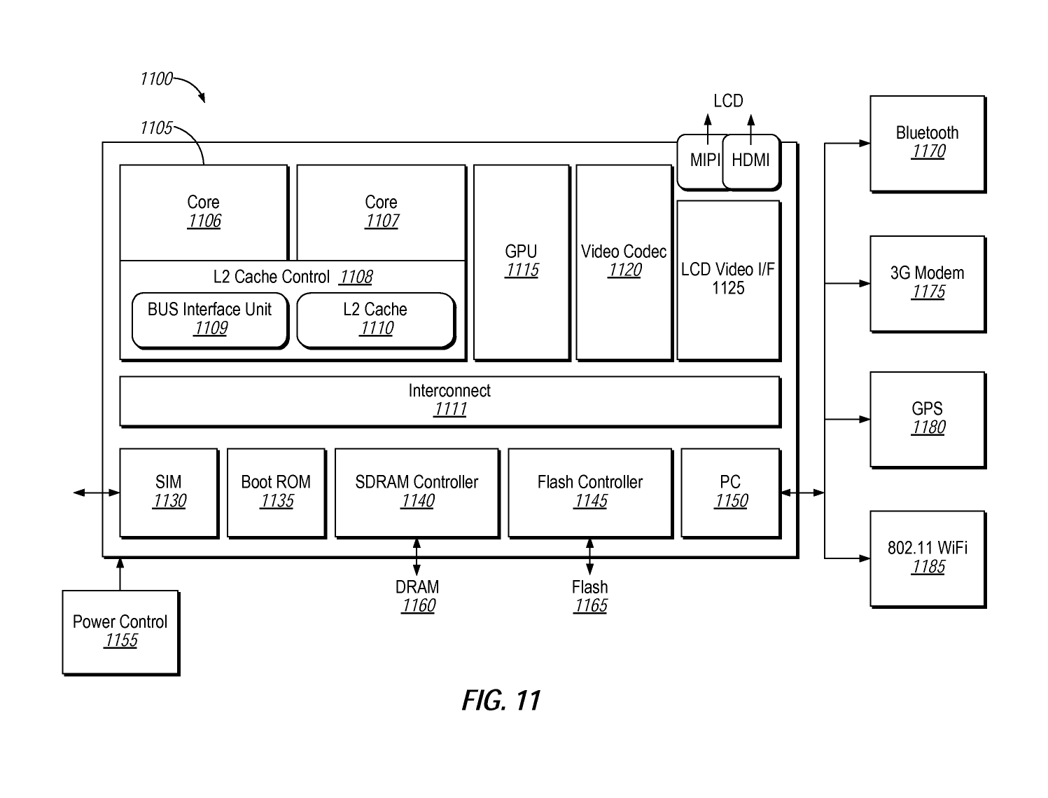

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

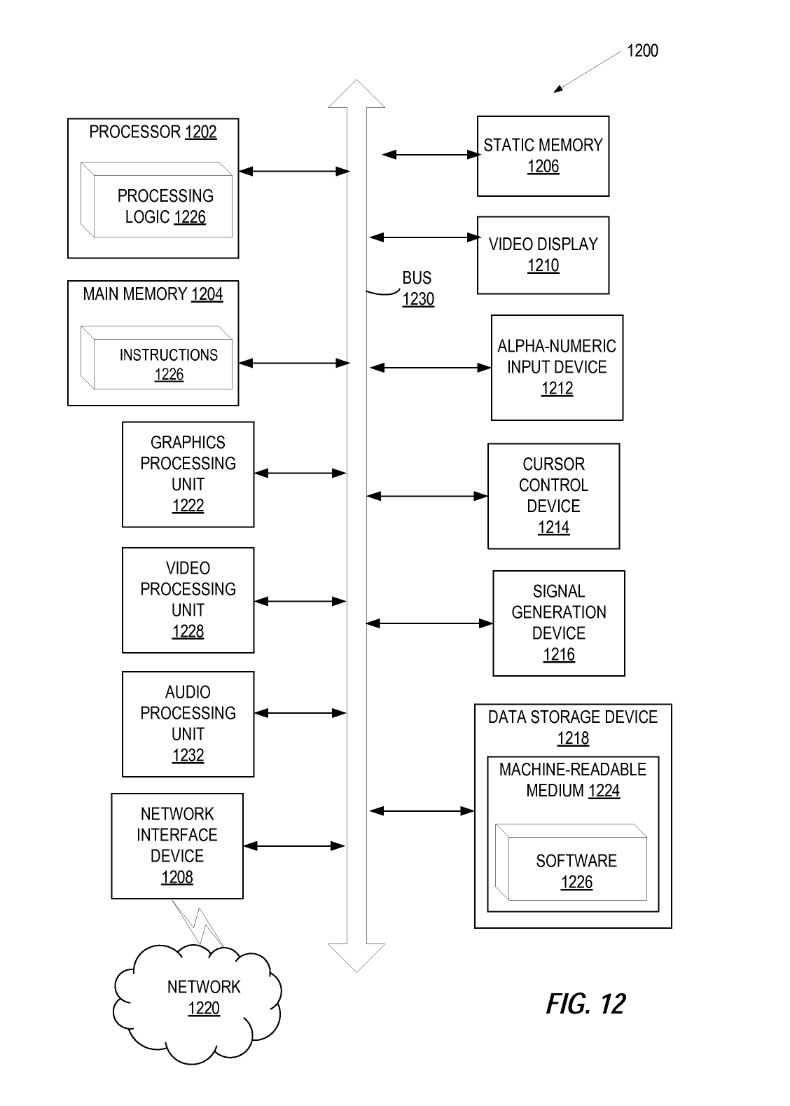

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction and/or a software library containing methods that call the above applications. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processing device that may include an interconnect and a processing core, coupled to the interconnect, to execute a plurality of virtual machines each being identified by a respective identifier, and tag, by an identifier of the first virtual machine, a first transaction initiated by a first virtual machine to access the interconnect.

In Example 2, the subject matter of claim 1 can optionally provide that the interconnect comprises a memory firewall to, responsive to receiving the first transaction, validate the first transaction using the identifier of the first virtual machine.

In Example 3, the subject matter of any one of Examples 1 and 2 can optionally further include a bus master, coupled to the interconnect, in which the processing core assigns to the bus master an identifier of the second virtual machine for which the bus master executes a second transaction to access the interconnect, and wherein the bus master tags the second transaction with the second identifier.

In Example 4, the subject matter of Example 3 can optionally provide that the interconnect is coupled to a memory, and wherein the memory firewall is further to at least one of: responsive to receiving the first transaction from the processing core, validate the first transaction with respect to a first address range of the memory and the identifier of the first virtual machine, or responsive to receiving the second transaction from the bus master, validate the second transaction with respect to a second address range of the memory and the identifier of the second virtual machine.

In Example 5, the subject matter of Example 4 can optionally provide that the interconnect is coupled to a peripheral device, and wherein the interconnect comprises a peripheral firewall to perform at least one of: responsive to receiving the first transaction from the processing core, validate the first transaction using the identifier of the first virtual machine, or responsive to receiving the second transaction from the bus master, validate the second transaction using the identifier of the second virtual machine.

In Example 6, the subject matter of Example 5 can optionally provide that the processing core is further to execute a virtual machine manager that manages the plurality of virtual machines, and wherein the virtual machine manager is associated with an access privilege allowing to access the interconnect and the bus master.

In Example 7, the subject matter of Example 6 can optionally provide that the processing core is to execute the virtual machine manager to set up at least one of a rule table of the memory firewall or a rule table of the peripheral firewall.

In Example 8, the subject matter of Example 6 can optionally provide that the processing core executes the virtual machine manager to create the first virtual machine and provide a virtual machine context for subsequent transactions until an exit of the first virtual machine.

In Example 9, the subject matter of Example 1 can optionally provide that the identifier of the first virtual machine is stored in an internal register of the processing core.

Example 10 is a system-in-a-chip (SoC) that can include a processing core to execute a plurality of virtual machines, and an interconnect, coupled to the processing core, the interconnect including a firewall to: receive a first transaction from the processing core, the first transaction being associated with a identifier of a first virtual machine, and determine, using the identifier of the first virtual machine, if the first transaction is allowed to access one of a memory coupled to the interconnect or a peripheral device coupled to the interconnect.

In Example 11, the subject matter of Example 10 can optionally provide that processing core is further to tag the first transaction with the first identifier of the first virtual machine.

In Example 12, the subject matter of Example 10 can optionally provide that to determine further includes to validate the first transaction in view of one or more rules of the firewall using the identifier of the first virtual machine.

In Example 13, the subject matter of Example 10 can further include a bus master, coupled to the interconnect, in which the bus master is assigned with an identifier of a second virtual machine for which the bus master executes a second transaction to access the interconnect, and wherein the bus master tag the second transaction with the identifier of the second virtual machine.

In Example 14, the subject matter of any one of Examples 10 to 23 can optionally provide that the firewall is further to at least one of: responsive to receiving the first transaction, validate the first transaction with respect to a first address range of the memory and the identifier of the first virtual machine, or responsive to receiving the second transaction from the bus master, validate the second transaction with respect to a second address range of the memory and the identifier of the second virtual machine.

In Example 15, the subject matter of Example 10 can optionally provide that the processing core further executes a virtual machine manager that manages the plurality of virtual machines, and wherein the virtual machine manager is associated with an access privilege allowing to access the interconnect and the bus master.

In Example 16, the subject matter of Examples 10 and 15 can optionally provide that the processing core executes the virtual machine manager to set up the firewall.

In Example 17, the subject matter of Example 16 can optionally provide that creation of the first virtual machine provides a virtual machine context for subsequent transactions until an exit of the first virtual machine.

In Example 18, the subject matter of any one of Examples 10 and 15 can optionally provide that the identifier of the first virtual machine is stored in an internal register of the processing core.

Example 19 is a method that includes starting a virtual machine manager, launching a virtual machine, assigning, by the virtual machine manager, an identifier to the virtual machine, and tagging a first transaction of the virtual machine by the identifier.

In Example 20, the subject matter of Example 19 can further include transmitting the transaction including the identifier to an interconnect.

In Example 21, the subject matter of any one of Examples 19 and 20 can further include assigning the identifier to a bus master, in which the bus master transmits a second transaction to the interconnect on behalf of the virtual machine.

In Example 22, the subject matter of any one of Examples 10 to 20 can optionally provide that the interconnect comprises a memory firewall to, responsive to receiving the first transaction, validate the first transaction using the identifier.

Example 23 is a machine-readable non-transitory medium having stored thereon program codes that, when executed, perform operations, the operations including starting a virtual machine manager, launching a virtual machine, assigning, by the virtual machine manager, an identifier to the virtual machine, and tagging a first transaction of the virtual machine by the identifier.

In Example 24, the subject matter of Example 23 can optionally provide that the operations further include transmitting the transaction including the identifier to an interconnect.

Example 25 is a processing system including an interconnect and means coupled to the interconnect for executing a plurality of virtual machines, each virtual machine being identified by a respective identifier and tagging, by an identifier of the first virtual machine, a first transaction initiated by a first virtual machine to access the interconnect.

In Example 26, the subject matter of Example 25 can optionally provide that the interconnect includes a memory firewall to, responsive to receiving the first transaction, validate the first transaction using the identifier of the first virtual machine.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processing system, comprising:
an interconnect; and
a processing core, coupled to the interconnect, to
execute a plurality of virtual machines, each virtual machine being identified by a respective identifier; and
tag, by an identifier of the first virtual machine, a first transaction initiated by a first virtual machine to access the interconnect.

2. The processing system of claim 1, wherein the interconnect comprises a memory firewall to, responsive to receiving the first transaction, validate the first transaction using the identifier of the first virtual machine.

3. The processing system of claim 2, further comprising:
a bus master, coupled to the interconnect,
wherein the processing core assigns to the bus master an identifier of the second virtual machine for which the bus master executes a second transaction to access the interconnect, and wherein the bus master tags the second transaction with the second identifier.

4. The processing system of claim 3, wherein the interconnect is coupled to a memory, and wherein the memory firewall is further to at least one of:
responsive to receiving the first transaction from the processing core, validate the first transaction with respect to a first address range of the memory and the identifier of the first virtual machine; or
responsive to receiving the second transaction from the bus master, validate the second transaction with respect to a second address range of the memory and the identifier of the second virtual machine.

5. The processing system of claim 4, wherein the interconnect is coupled to a peripheral device, and wherein the interconnect comprises a peripheral firewall to perform at least one of:
responsive to receiving the first transaction from the processing core, validate the first transaction using the identifier of the first virtual machine; or
responsive to receiving the second transaction from the bus master, validate the second transaction using the identifier of the second virtual machine.

6. The processing system of claim 5, wherein the processing core is further to execute a virtual machine manager that manages the plurality of virtual machines, and wherein the virtual machine manager is associated with an access privilege allowing to access the interconnect and the bus master.

7. The processing system of claim 6, wherein the processing core is to execute the virtual machine manager to set up at least one of a rule table of the memory firewall or a rule table of the peripheral firewall.

8. The processing system of claim 6, wherein the processing core executes the virtual machine manager to create the first virtual machine and provide a virtual machine context for subsequent transactions until an exit of the first virtual machine.

9. The processing device of claim 1, wherein the identifier of the first virtual machine is stored in an internal register of the processing core.

10. A system-in-a-chip (SoC), comprising:
a processing core to execute a plurality of virtual machines; and
an interconnect, coupled to the processing core, comprising a firewall to:
receive a first transaction from the processing core, the first transaction being associated with a identifier of a first virtual machine; and
determine, using the identifier of the first virtual machine, if the first transaction is allowed to access one of a memory coupled to the interconnect or a peripheral device coupled to the interconnect.

11. The SoC of claim 10, wherein the processing core is further to:
tag the first transaction with the first identifier of the first virtual machine.

12. The SoC of claim 10, wherein to determine further comprises to:
validate the first transaction in view of one or more rules of the firewall using the identifier of the first virtual machine.

13. The SoC of claim 10, further comprising:
a bus master, coupled to the interconnect,
wherein the bus master is assigned with an identifier of a second virtual machine for which the bus master executes a second transaction to access the interconnect, and wherein the bus master tag the second transaction with the identifier of the second virtual machine.

14. The SoC of claim 13, wherein the firewall is further to at least one of:
responsive to receiving the first transaction, validate the first transaction with respect to a first address range of the memory and the identifier of the first virtual machine; or
responsive to receiving the second transaction from the bus master, validate the second transaction with respect to a second address range of the memory and the identifier of the second virtual machine.

15. The SoC of claim 10, wherein the processing core further executes a virtual machine manager that manages the plurality of virtual machines, and wherein the virtual machine manager is associated with an access privilege allowing to access the interconnect and the bus master.

16. The SoC of claim 15, wherein the processing core executes the virtual machine manager to set up the firewall.

17. The SoC of claim 16, wherein creation of the first virtual machine provides a virtual machine context for subsequent transactions until an exit of the first virtual machine.

18. The SoC of claim 15, wherein the identifier of the first virtual machine is stored in an internal register of the processing core.

19. A method, comprising:
starting a virtual machine manager;
launching a virtual machine;
assigning, by the virtual machine manager, an identifier to the virtual machine; and
tagging a first transaction of the virtual machine by the identifier.

20. The method of claim 19, further comprise:
transmitting the transaction including the identifier to an interconnect.

21. The method of claim 20, further comprising:
assigning the identifier to a bus master,
wherein the bus master transmits a second transaction to the interconnect on behalf of the virtual machine.
